(19) United States
(12) Patent Application Publication
(10) Pub. No.: US 2022/0035777 A1
(43) Pub. Date: Feb. 3, 2022

(54) PAIR SELECTION FOR ENTITY RESOLUTION ANALYSIS

(71) Applicant: International Business Machines Corporation, Armonk, NY (US)

(72) Inventors: Abhishek Seth, Deoband (IN); Soma Shekar Naganna, Bangalore (IN); Geetha Sravanthi Pulipaty, Bangalore (IN); Rishabh Saraf, Siliguri (IN); Mohit Singh Chouhan, Jaipur (IN)

(21) Appl. No.: 16/941,636

(22) Filed: Jul. 29, 2020

(51) Int. Cl. G06F 16/215; G06N 5/04

(52) U.S. Cl. CPC G06F 16/215; G06N 5/04

(57) ABSTRACT

Analyzing entity matching systems by determining autolink (AL) and clerical review (CR) threshold values according to record pair compare method scores, defining a score region of interest adjacent to at least one of the AL or CR thresholds, identifying anomalous pairs in at least one region of interest, and providing at least one anomalous record pair to a user for review.

### BACKGROUND

The disclosure relates generally to record pair analysis in entity resolution systems. The disclosure relates particularly to selecting sample record pair data according to record pair anomalies.

Master data management (MDM) systems collect records coming from various sources, match the records' information like Name, Address, Identifiers etc. using extensive probabilistic matching features and generate a cumulative score. Matching record pair data requires comparing different record attribute values (e.g., Name, Address, Identifiers, etc.) from each pair of records to determine if they match and should subsequently be linked, based on a series of mathematically derived statistical probabilities and complex weight tables.

Attribute comparison functions check for a variety of matching conditions like exact, edit distance, N-GRAM, phonetic, or partial matching. Scores are generated based on the outcome of these comparisons, and sub scores from each attribute are combined based on statistically determined relative weights. Using statistically defined thresholds within the system, pairs of records are considered as matched, unmatched, or indeterminant and sent to Clerical Review.

Scores over a threshold, called Autolink (AL), indicate both the records are same. Scores below another threshold, called Clerical Review (CR), indicate the records are different. Scores falling between the AL and CR thresholds are indeterminant and need a manual intervention by a data steward to determine if the records are the same or different.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the analysis of master data management entity matching systems.

Aspects of the invention disclose methods, systems and computer readable media associated with analyzing entity matching systems by determining autolink (AL) and clerical review (CR) threshold values according to record pair compare method scores, defining a score region of interest adjacent to at least one of the AL or CR thresholds, identifying anomalous pairs in at least one region of interest, and providing at least one anomalous record pair to a user for review. By selecting anomalous pairs from only score regions of interest near the AL and CR threshold values, the method reduces the number of pairs presented to a user for review and feedback. the user's workload and time required for the review are reduced.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

In an embodiment, one or more components of the system can employ hardware and/or software to solve problems that are highly technical in nature (e.g., determining AL and CR thresholds for use in matching pairs, defining regions of interest near the AL and CR thresholds, identifying anomalous pairs within at least one region of interest, etc.). These solutions are not abstract and cannot be performed as a set of mental acts by a human due to the processing capabilities needed to facilitate MDM system performance analysis, for example. Further, some of the processes performed may be performed by a specialized computer for carrying out defined tasks related to MDM operations. For example, a specialized computer can be employed to carry out tasks related to MDM matching performance evaluation, or the like.

MDM system users run sample record pair analysis, using datasets selected from their previous MDM data, to evaluate MDM matching engine performance including the effectiveness of the current AL, and CR thresholds, and system weights used in the matching process. Samples are chosen for the score ranges—blow CR, between CR and AL, and above AL—using parameters including minimum score, maximum score and desired number of pairs at each score. Selecting pairs in this manner generates as few or as many pairs as the user desires. The selected pairs may not be the most relevant for evaluating the AL and CR thresholds, or system matching weights, as pairs are selected solely based upon matching process scores and without regard to the attribute matching scores making up the overall matching process score. As an example, a record pair may be selected as having the desired score below the CR threshold without regard for which of the attribute compare method scores resulted in the score below the CR threshold. Poorly set attribute compare weights and thresholds may yield false negatives—matched pairs in the view of a user—with overall scores below the CR, and false positives—unmatched pairs in the view of a user—above the AL. Record pair selection solely based upon overall score will not necessarily identify such anomalous pairs to the user for review. Without such a review and the accompanying feedback and adjustments, the MDM system may erroneously be viewed by the user as functioning well.

Disclosed systems and methods enable sampling the pairs by identifying anomalous pairs in defined regions of interest associated with determined AL and CR threshold values. In an embodiment, the disclosed systems and methods provide the identified anomalous pairs to the user and receive user feedback regarding the anomalous pairs. The systems and methods improve the accuracy of the matching engine by adjusting the AL and CR thresholds and attribute compare method weightings, according to the user feedback regarding the anomalous pairs.

Pairs are identified as anomalous according to selection rules associated with attribute compare methods and defined separately for each score region of interest. By selecting only anomalous pairs, the disclosed inventions reduce the number of pairs selected for review by the user and reduce the amount of time required for the review. By receiving feedback from the user regarding the anomalous pairs, the disclosed inventions fine tune the AL and CR thresholds and adjust attribute compare weightings according to user identified false positives (unmatched pairs erroneously scored above the AL) and false negatives (matched pairs erroneously scored below the CR), improving overall MDM system matching performance, and user confidence in the MDM matching.

In an embodiment, the method groups the set of identified anomalous pairs into clusters according to common attribute compare method features. The method then selects representative pairs from each cluster and provides the selected pairs to the user, further reducing the user's workload and time requirements, while providing pairs representative of the performance of the current thresholds and attribute compare method weightings.

Disclosed systems and methods select pairs having high likelihoods of being either false negatives or false positives—thereby providing an opportunity to fine tune the matching process parameters to reduce false positives and false negatives through adjustments to parameters according to user feedback.

In an embodiment, the method considers pairs from the MDM dataset of the user's system. Each record pair includes a set of attribute-compare method scores associated with the various attributes of the underlying records. The attribute compare method scores may be derived from comparisons of feature vectors generated for each underlying record of the pair of records. Record attributes may have weights assigned to them according to the significance of each attribute in supporting a match or indicating an unmatched state, or an indeterminant (CR) state, for the pair. Attribute weights may be adjusted according to relative contributions made by each attribute in support of a matched status across a set of record comparisons among the MDM system data. The frequency with which particular attributes are associated with matched record pair determination may also affect attribute weighting and overall record pair comparison scores.

The method normalizes the attribute compare method scores for each attribute of each considered pair. Exemplary attributes include name, address, date of birth, gender identity, phone number, city, state/province, driver's license number, postal code, etc. In this embodiment, the method normalizes the scores for the set of attribute scores with respect to the maximum score for the attribute compare method among the considered pairs. The normalization yields a normalized attribute score set with values between 0 and 1 for each attribute. In this embodiment, the method considers only positive attribute compare method scores as negative attribute compare method scores do not support a “match” determination.

In this embodiment, the method generates binary values for each attribute of each considered record pair from the set of normalized scores for the attribute. The method defines a threshold for each attribute compare method and then sets all scores above the threshold to 1, and all scores below the threshold to 0. Binary values of 1 indicate attributes which support a match of the record pair while binary values of 0 indicate attributes which do not support a match for the pair.

As an example, the method sets the threshold values to 0.8, though other threshold values may be selected by a user. For the example, the method converts all normalized scores greater than 0.8 to 1 and all scores less than or equal to 0.8 to 0. The raising or lowering the threshold values alters the weightings for the associated attribute. Raising the threshold yields fewer scores having a value of 1 and reduces the weighting of the associated attribute among the set of attributes. Lowering the threshold values increases the number of scores having a value of 1 and results in an increased weighting for the associated attribute among the set of attributes.

After normalization and binarization of the attribute scores, the method identifies related attribute compare methods—those attribute-compare methods which correlate with a match determination as indicated by the average of all binarized values for the attribute among considered pairs exceeds a correlation threshold. As an example, for the attribute “name” the average of all binarized scores across the set of considered pairs equals 0.51, for the example, the method evaluates attributes using a correlation factor of 0.4, but other correlation factors are possible and alter the attribute weighting. Raising the threshold value reduces the number of related attribute-compare methods considered correlated to a match and lowering the threshold increases the number of related attribute-compare methods considered correlated to a match.

In an embodiment, the method determines candidate AL and CR values for the identified set of related attribute-compare methods—those compare methods having average binary values exceeding the correlation threshold—and the method weights these attribute-compare methods at 1. (Attribute compare methods having average binary values less than the correlation threshold do not support a match and the method does not consider these attribute-compare methods in determining AL and CR thresholds—these attribute-compare methods are weighted at 0.) In this embodiment, the method calculates the candidate AL threshold value as the sum of the maximum score for each of the related attribute compare methods. In this embodiment, the method calculates the candidate CR threshold value as the sum of the average score for each of the related attribute compare methods. Table 1 provides an example of a determination of candidate AL and CR threshold values according to the relevant summed scores of the identified related attribute compare methods.

TABLE 1

| | | |
|---|---|---|
| Attribute Compare | Maximum | Average |
| Method | Score | Score |

Related Compare Methods (Correlation threshold 0.4)

| | | |
|---|---|---|
| Name Compare | 14 | 5.4 |
| Identifiers Compare | 18 | 8.3 |
| Address Compare | 12 | 6.6 |

Candidate Thresholds

| | | |
|---|---|---|
| Candidate CR | Σ (average related compare | 20.3 |
| | method scores) | |
| Candidate AL | Σ (maximum related compare | 44 |
| | method scores) | |

In an embodiment, the method defines four regions of interest: a CR minus region including pairs labeled as unmatched and having scores below the candidate CR threshold; a CR plus region including pairs labeled as CR by the matching process and having scores between the CR and AL thresholds; an AL minus region including pairs labeled as CR and having scores less than the AL threshold; and an AL plus region including pairs labeled as matched and having scores above the AL threshold. In an embodiment, the method defines the score regions of interest as CR and AL plus or minus a delta value set by default, set by user preference, or set according to empirical data from experience configuring and using MDM entity matching engines. A user may adjust or configure the respective CR and AL delta values to increase or decrease the number of scores in each region, as desired. Increasing a delta value expands the regions and increases the number of scores. Decreasing the delta value decreases the region and reduces the number of scores.

In an embodiment, pairs of the CR plus region and those of the AL minus region are all designated as CR pairs. In this embodiment, the delta value is insufficient to create any overlap between the score range CR to CR plus the delta value and the score range AL minus the delta to AL as the delta values. CR plus pairs typically have fewer matched attributes than AL minus pairs

The CR minus region may include false negatives—matched pairs labeled as unmatched. The CR threshold may be set too high, or the attribute compare method weights may be incorrectly underweighted, leading matched pairs to be labeled as unmatched. For pairs in this region, the method evaluates the percentage of related attribute compare methods—as described above—against a defined percentage cutoff threshold. In an embodiment, the method defines a cutoff threshold according to empirical test results using sample MDM data sets. As an example, the cutoff value may be defined as 40%. The method selects pairs having a higher percentage of binarized related attribute compare method values supporting a match than the cutoff threshold for presentation to the user as possible false negatives, for the example. pairs having more than 40% of their overall attributes supporting a match.

The CR plus region may include false positives—unmatched pairs labeled as matched −CR. It is possible that the CR threshold is too low, or that attribute compare scores are overweighed, leading to unmatched pairs being labeled as CR. The method evaluates the percentage of binarized related attribute compare method scores of CR labeled pairs against the defined cutoff. The method selects pairs having a percentage of binarized related attribute compare method values below the cutoff selected for presentation to the user as possible false positives.

The AL minus region may include false negatives—matched pairs labeled as unmatched or CR. The AL threshold may be set too high, or the attribute compare method weights may be incorrectly underweighted, leading matched pairs to be labeled as unmatched or CR. For pairs in this region, the method evaluates the percentage of related attribute compare methods—as described above—against a second defined percentage cutoff threshold—a different threshold than used for analyzing pairs associated with the CR minus and CR plus regions. In an embodiment, the method uses a greater value for the second defined cutoff than the cutoff value used for the CR threshold score regions analysist. As an example, the method uses 80% for the cutoff. The method selects pairs having a higher percentage of binarized related attribute compare method values supporting a match than the cutoff threshold for presentation to the user as possible false negatives. For the example, record pairs having more than 80% of their overall record pairs supporting a match are selected.

The AL plus region may include false positives—unmatched pairs labeled as matched. It is possible that the AL threshold is too low, or that attribute compare scores are overweighed, leading to unmatched CR pairs being labeled as AL. The method evaluates the percentage of binarized related attribute compare method scores of AL labeled pairs against the defined cutoff. The method selects pairs having a percentage of binarized related attribute compare method values below the cutoff for presentation to the user as possible false positives.

As an example, health care industry applications are not tolerant of false positives. Medicine administered to the wrong patient could have severe health consequences. Some of the compare attributes may have been over weighted pushing the record pair to the match (above the AL threshold) category, while there are other attributes which have not matched to an acceptable degree.

In an embodiment, the method groups selected pairs into clusters according to one or more clustering algorithms. Exemplary clustering algorithms include k-means clustering, and density-based scanning (DBScan). In this embodiment, the selected pairs are clustered according to similar patterns of binarized attribute compare method data. After clustering the method selects one record pair from each cluster and provides the relatively small set of pairs—one from each cluster—to the user for evaluation and feedback.

In an embodiment, the user reviews the provided pairs and generates feedback on each provided pair. The feedback relates to the classification of the record pair as correct or incorrect. Therefore, false positives and false negative are identified as such, and correctly labeled pairs are identified as correctly labeled. In this embodiment, the user provides the feedback to the disclosed systems and methods.

In an embodiment, the method utilizes the provided feedback to evaluate and potentially adjust the CR, AL, defined cutoff, correlation threshold, and attribute compare method weights to reduce the false positive and false negative rates. As an example, the method may adjust the AL or CR thresholds up after receiving feedback identifying false positives in CR plus or AL plus. Alternatively, the method may reduce the weights associated with the attribute compare methods contributing to the incorrectly high score for the respective false positive pairs. As an example, the method may adjust the AL or CR thresholds down after receiving feedback identifying false negatives in CR minus or AL minus. Alternatively, the method may increase the weights associated with the attribute compare methods contributing to the incorrectly low score for the respective false negative pairs.

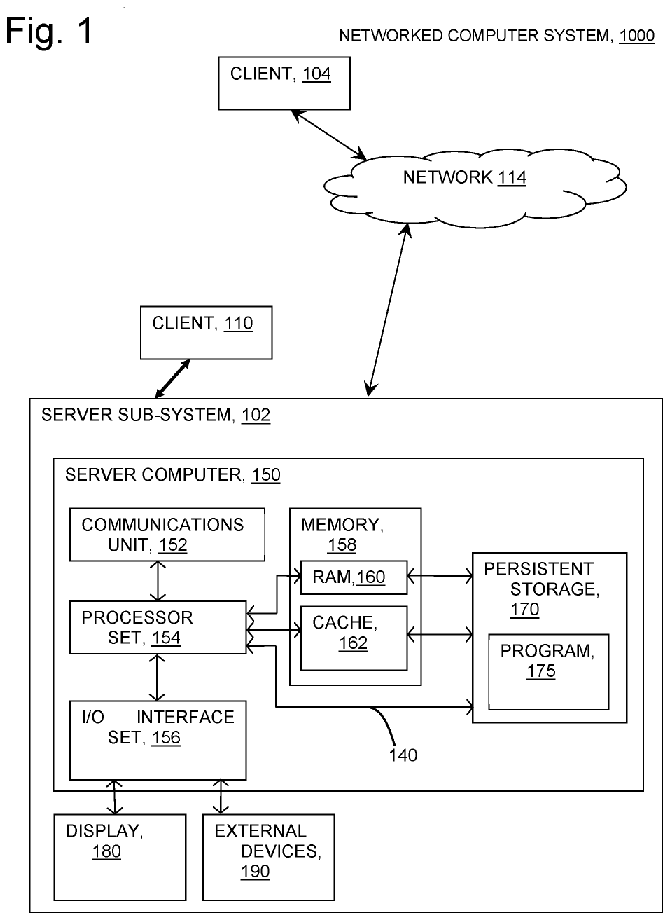

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise matching system analysis program (not shown) together with sufficient computing resource (processor, memory, network communications hardware) to execute the program. In an embodiment, client devices 104 and 110 constitute portions of an MDM system for matching entities across networked resources. As shown in FIG. 1, server sub-system 102 comprises a server computer 150 associated with the MDM system and matching entities. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158. In an embodiment, memory 158 stores MDM records and their associated entity matching data.

Program instructions and data used to practice embodiments of the present invention, e.g., matching system analysis program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110, edge cloud, and cloud resource (not shown). In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152. Communications unit 152 enables user interactions with the MDM and for the disclosed embodiments, the matching system analysis program 175.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., matching system analysis program 175 on server computer 150, can be stored on such portable computer readable storage media and can be loaded onto persistent storage 170 via I/O interface(s) 156. I/O interface(s) 156 also connect to a display 180. MDM records and user requests and feedback pass through I/O interface 156.

Display 180 provides a mechanism to display data to a user and may be, for example, a computer monitor. Display 180 can also function as a touch screen, such as a display of a tablet computer.

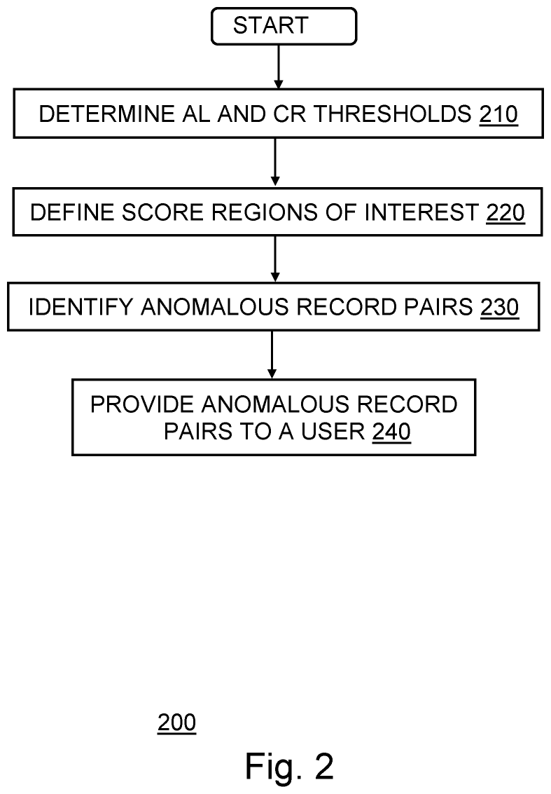

FIG. 2 provides a flowchart 200, illustrating exemplary activities associated with the practice of the disclosure. After program start, at block 210, the method of matching system analysis program 175, of FIG. 1, determines candidate AL and CR threshold values according to record pair attribute compare method scores. In an embodiment, AL relates to a sum of maximum scores of attributes related to a matched status while CR relates to a sum of average scores for attributes related to a matched status.

In an embodiment, the method normalizes record pair attribute scores according to the maximum score for the attribute and binarizes the normalized scores according to a defined binarization threshold. These steps yield a set of binarized data associated with the set of attributes for each record pair evaluated. The method identifies binary values of 1 with attributes related to matched record pairs or in support of a matched status, and binary values of 0 as unrelated attributes, not in support of the matched status. For normalization, the method considers only positive scores as negative scores do not correlate with matched pairs. In an embodiment, the method considers the average of all binarized values of an attribute across the set of considered record pairs with regard to a defined correlation factor. Attributes having average binarized values above the correlation factor are considered related while attributes having average binarized values below the correlation threshold are not considered related.

In this embodiment, the method calculates the AL threshold as the sum of the maximum values of the related attributes and calculates CR as the sum of the average values of the related attributes. Unrelated attributes are not considered in determining the CR and AL threshold values.

At block 220, the method of matching system analysis program 175 defines four score regions of interest adjacent to the CR and AL threshold values: CR minus, CR plus, AL minus, and AL plus. In an embodiment, the four regions are defined as CR plus or minus a delta CR score, and AL plus or minus a delta AL score, where the delta CR and delta AL scores are determined according to user preferences relating to the desired number of record pairs associated with each score region of interest. Increasing the delta CR and delta AL values increases the umber of record pairs added to each set.

At block 230, the method of matching system analysis program 175 identifies anomalous record pairs in at least one but more typically all four regions of interest. the method defines selection rules for each of the four regions associated with a percentage of binarized attribute compare method values threshold. the rules relate to such percentages falling above or below the defined cutoff threshold. The method determines the cutoff threshold according to default values or based upon user experience configuring MDM systems and analyzing the entity matching engines.

At block 240, the method provides the selected anomalous pairs to a user for review and feedback. In an embodiment, the method groups all selected pairs into clusters according to patterns in their binarized attribute compare method scores. In this embodiment, the method selects a single record pair from each cluster for the user. These steps further reduce the number of record pairs presented to the user for review and feedback.

In an embodiment, the user provides feedback regarding the provided records including identifying false positives, false negatives, and correctly categorized record pairs. In an embodiment, the method utilizes the feedback to adjust at least one the AL, CR, correlation factor, and attribute method compare weights used to derive record pair scores.

MDM systems may include large data sets (big data) and may be distributed across complex networked computing environments including both local networks as well as edge cloud and cloud network resources. As MDM datasets grow, ongoing evaluation of the current matching process parameters requires review of ever larger sets of previously matched pairs. Disclosed embodiments reduce the resource burden associated with such reviews by reducing the set of review pairs to a single record pair per cluster for pairs selected as anomalous from the CR minus, CR plus, AL minus and AL plus regions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

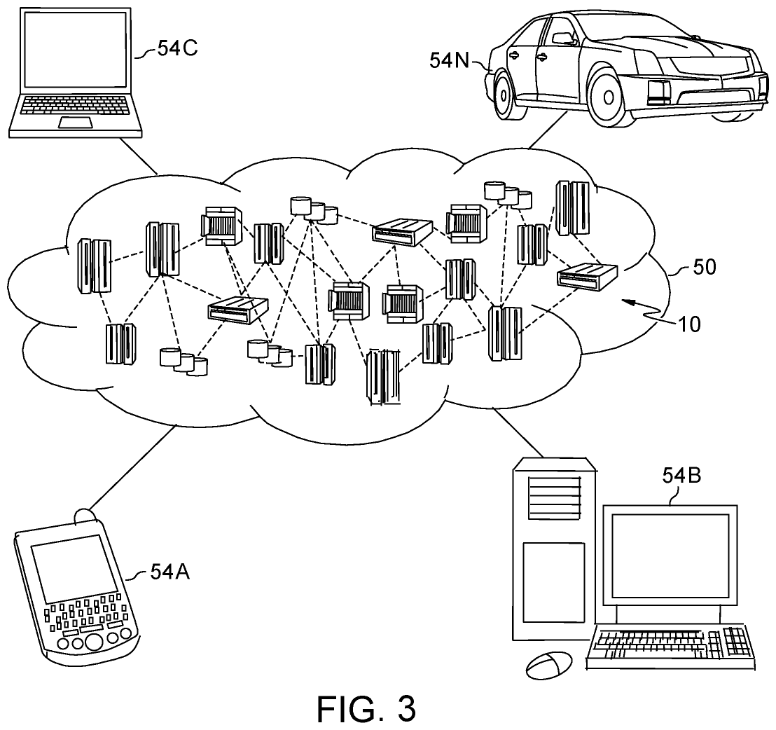

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

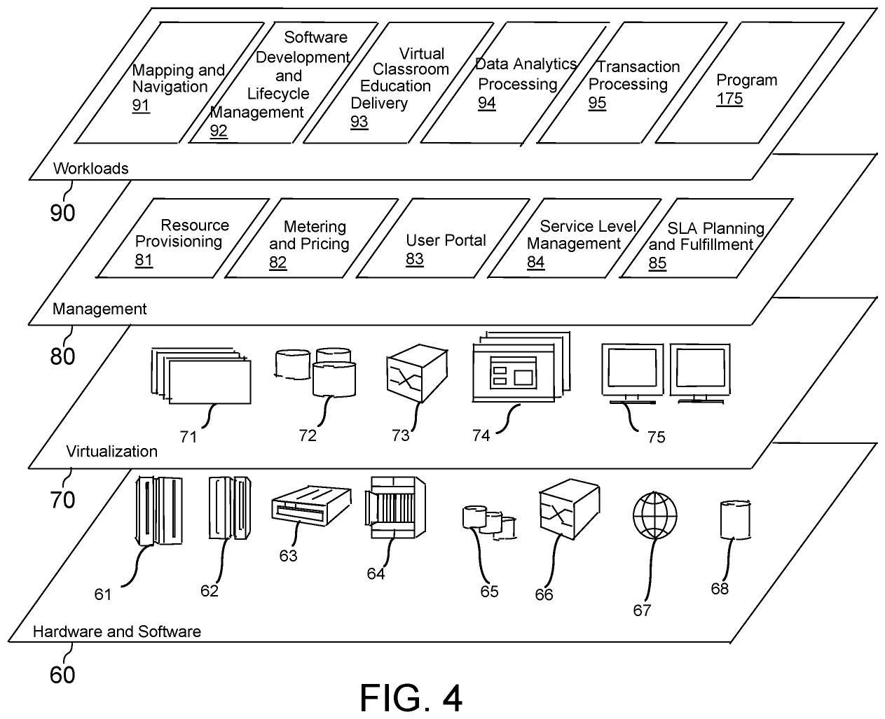

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and matching system analysis program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for analyzing entity matching systems, the method comprising:
determining, by one or more computer processors, an autolink (AL) threshold value according to record pair attribute compare method maximum scores;
determining, by one or more computer processors, a clerical review (CR) threshold value according to record pair attribute compare method average scores;
defining, by the one or more computer processors, score regions of interest adjacent to at least one of the AL or CR thresholds;
identifying, by the one or more computer processors, at least one anomalous record pair in at least one score region of interest; and
providing, by the one or more computer processors, at least one anomalous record pair to a user for review.

2. The computer implemented method according to claim 1, further comprising:
defining, by the one or more computer processors, an anomalous record pair selection rule for at least one score region of interest; and
identifying, by the one or more computer processors, an anomalous record pair according to the anomalous record pair selection rule.

3. The computer implemented method according to claim 1, further comprising:
grouping, by the one or more computer processors, anomalous record pairs into clusters according to attribute comparison scores; and
providing, by the one or more computer processors, the user an anomalous record pair from a cluster.

4. The computer implemented method according to claim 1, further comprising normalizing, by the one or more computer processors, a record pair attribute compare method score according to a maximum score for the attribute.

5. The computer implemented method according to claim 1, further comprising converting, by the one or more computer processors, a record pair attribute compare method score to a binary value.

6. The computer implemented method according to claim 1, further comprising:
receiving, by the one or more computer processors, user feedback associated with the anomalous record pair; and
adjusting, by the one or more computer processors, at least one of the AL or CR threshold value according to the user feedback.

7. The computer implemented method according to claim 1, further comprising:
defining, by the one or more computer processors, an anomalous record pair selection rule for at least one score region of interest;
identifying, by the one or more computer processors, an anomalous record pair according to the anomalous record pair selection rule;
grouping, by the one or more computer processors, anomalous record pairs into clusters according to attribute comparison scores;
providing, by the one or more computer processors, the user an anomalous record pair from a cluster;
receiving, by the one or more computer processors, user feedback associated with the anomalous record pair; and
adjusting, by the one or more computer processors, at least one of the AL or CR threshold value according to the user feedback.

8. A computer program product for analyzing entity matching systems, the computer program product comprising one or more computer readable storage devices and collectively stored program instructions on the one or more computer readable storage devices, the stored program instructions comprising:
program instructions to determine an autolink (AL) threshold value according to record pair attribute compare method maximum scores;
program instructions to determine a clerical review (CR) threshold value according to record pair attribute compare method average scores;
program instructions to define a score regions of interest adjacent to at least one of the AL or CR thresholds;
program instructions to identify at least one anomalous record pair in at least one score region of interest; and
program instructions to provide at least one anomalous record pair to a user for review.

9. The computer program product according to claim 8, the stored program instructions further comprising:
program instructions to define an anomalous record pair selection rule for at least one score region of interest; and
program instructions to identify an anomalous record pair according to the anomalous record pair selection rule.

10. The computer program product according to claim 8, the stored program instructions further comprising:
program instructions to group anomalous record pairs into clusters according to attribute comparison scores; and
program instructions to provide the user an anomalous record pair from a cluster.

11. The computer program product according to claim 8, the stored program instructions further comprising program instructions to normalize a record pair attribute compare method score according to a maximum score for the attribute.

12. The computer program product according to claim 8, the stored program instructions further comprising program instructions to convert a record pair attribute compare method score to a binary value.

13. The computer program product according to claim 8, the stored program instructions further comprising:
program instructions to receive user feedback associated with the anomalous record pair; and
program instructions to adjust at least one of the AL or CR threshold value according to the user feedback.

14. The computer program product according to claim 8, the stored program instructions further comprising:
program instructions to define an anomalous record pair selection rule for at least one score region of interest;
program instructions to identify an anomalous record pair according to the anomalous record pair selection rule;
program instructions to group anomalous record pairs into clusters according to attribute comparison scores;
program instructions to provide the user an anomalous record pair from a cluster;
program instructions to receive user feedback associated with the anomalous record pair; and
program instructions to adjust at least one of the AL or CR threshold value according to the user feedback.

15. A computer system for analyzing entity matching systems, the computer system comprising:
one or more computer processors;
one or more computer readable storage devices; and
stored program instructions on the one or more computer readable storage devices for execution by the one or more computer processors, the stored program instructions comprising:
program instructions to determine an autolink (AL) threshold value according to record pair attribute compare method maximum scores;
program instructions to determine a clerical review (CR) threshold value according to record pair attribute compare method average scores;
program instructions to define a score regions of interest adjacent to at least one of the AL or CR thresholds;
program instructions to identify anomalous pairs in at least one score region of interest; and
program instructions to provide at least one anomalous record pair to a user for review.

16. The computer system according to claim 15, the stored program instructions further comprising:
program instructions to define an anomalous record pair selection rule for at least one score region of interest; and
program instructions to identify an anomalous record pair according to the anomalous record pair selection rule.

17. The computer system according to claim 15, the stored program instructions further comprising:
program instructions to group anomalous record pairs into clusters according to attribute comparison scores; and
program instructions to provide the user an identified record pair from each cluster.

18. The computer system according to claim 15, the stored program instructions further comprising program instructions to convert a record pair attribute compare method score to a binary value.

19. The computer system according to claim 15, the stored program instructions further comprising:
program instructions to receive user feedback associated with the anomalous record pair; and
program instructions to adjust at least one of the AL or CR threshold value according to the user feedback.

20. The computer system according to claim 15, the stored program instructions further comprising:
program instructions to define an anomalous record pair selection rule for at least one score region of interest;
program instructions to identify an anomalous record pair according to the anomalous record pair selection rule;
program instructions to group anomalous record pairs into clusters according to attribute comparison scores;
program instructions to provide the user an anomalous record pair from a cluster;
program instructions to receive user feedback associated with the anomalous record pair; and
program instructions to adjust at least one of the AL or CR threshold value according to the user feedback.
